(19) United States
(12) Patent Application Publication
(10) Pub. No.: US 2003/0004739 A1
(43) Pub. Date: Jan. 2, 2003

(54) Method and apparatus using e-commerce and a third party facilitator to facilitate the transfer of utility assets

(76) Inventor: Robert Nolan Mcever, Suwanee, GA (US)

Correspondence Address: Leonard W. Pojunas, Schlumberger Resource Management Services, Inc., 5430 Metric Place, Norcross, GA, 30092, US

(21) Appl. No.: 09/896,473

(22) Filed: Jun. 29, 2001

(51) Int. Cl. G06F 17/60

(52) U.S. Cl. 705/1; 705/26; 705/7

(57) ABSTRACT

An e-commerce based data processing system and associated method utilizes e-commerce technologies and a third company facilitator to facilitate the completion of a business transaction, which could involve the transfer, sale, or trade of utility-based commodity's customer base (or a portion of its customer base), the data processing system including a third server which is adapted for use by a third facilitator company, that third server being accessible via the internet to a first server that is adapted for use by one or more first company potential business partners and to a second server that is adapted for use by one or more second company potential business partners, the third company functioning as a facilitator for facilitating a culmination or a completion of a business transaction between any of the first company potential business partners and any of the second company potential business partners.

### BACKGROUND OF THE INVENTION

The present invention relates to a method and apparatus for facilitating the completion of a business transaction between one or more first company potential business partners and one or more second company potential business partners. More specifically, the invention relates to a multiple computer-based and internet-based data processing system adapted for allowing a third company to function as a facilitator for facilitating the completion of a business transaction between one or more first company potential business partners and one or more second company potential business partners. The third company stores a plurality of data, including but not limited to customer data, which is accessible via the internet by the first company potential business partners and the second company potential business partners. This allows the third company to function as a facilitator for the purpose of facilitating the culmination or completion of a business transaction pertaining to the plurality of data, between a first company potential business partner and a second company potential business partner.

Before the deregulation of the electric and gas utility industries, these utilities provided energy services to a wide range of customer-types. These customer-types included industrial customers (such as manufacturing plants and large business buildings), commercial customers (such as supermarkets and retail centers), and residential customers (such as residential homes). However, since the deregulation of the electric and gas utility industries, energy service providers (those entities responsible for supplying energy to the end-use customers), in an effort to compete against other energy service providers, are establishing niche markets. For example, as a result of deregulation, energy service provider A may decide to supply energy only to high-end residential customers, energy service provider B may decide to supply energy only to industrial customers, energy service provider C may decide to supply energy only to small commercial customers and low-end residential customers, and energy service provider D may decide to supply energy only to electricity customers (as opposed to both electricity and gas customers).

Energy service providers may decide to service a particular niche market for a number of reasons. The following two reasons are illustrative only and are not an exhaustive list of the many reasons an energy service provider may decide to do so. First, by servicing only one type of customer, the energy service provider can implement marketing and promotional campaigns customized for that particular customer-type. For example, energy service provider A may market or promote its services to its niche market—the high end residential market—by tying its programs to other incentive programs—such as frequent flier mileage programs, auto-rental programs, and home-security programs. Similarly, as an incentive for using its services, energy service provider B may offer its industrial customers special hardware or software tools that will assist its customers in managing or controlling their loads.

Second, an energy service provider may need to service a particular niche market because it is only able to supply energy to certain customer-types with specific load requirements. For example, energy service provider A may only be able to service residential-type loads and may be unable to provide energy to the more complex load requirements of an industrial or commercial-type customer. Similarly, energy service provider D may decide it only wants to remain in the electricity industry and therefore decide to sell off its gas business.

Once an energy service provider decides to provide energy only to a niche market, it will want to (or may need to) transfer certain specific assets that are as a result no longer needed. A transfer may include a sale of existing assets or a trade of existing assets for the assets, goods, or services of another energy service provider. Assets that may be transferred may include, but are not limited to, a utility's customer base or a specified portion of a utility's customer base. In one embodiment, an energy service provider may want to “sell” or “trade” an existing customer base that it no longer plans to service. For example, once energy service provider A decides to service only high-end residential customers, it will want to transfer (i.e., “sell” or “trade”) its existing industrial, commercial, and small-residential type customer base. Similarly, once energy service provider B decides to service only industrial-type customers, it will want to transfer (i.e., “sell” or “trade”) its existing commercial and residential-type customer base. Energy service provider C will want to transfer (i.e., “sell” or “trade”) its industrial, large commercial and large residential customers, so that it will only supply service to small commercial and low-end residential customers. Energy service provider D will want to transfer (i.e., “sell” or “trade”) its gas customers, so that it will only supply service to its electricity customers. Thus, the customer base that an energy service provider no longer plans to service is a potential revenue-generating asset of the energy service provider for which there is a market in the deregulated utility environment.

In the before-mentioned example, energy service provider A may be interested in buying energy service provider B's or C's high-end residential customers; energy service provider B may be interested in buying energy service provider A's or C's industrial customers; energy service provider C may be interested in buying energy service provider A's or B's commercial and low-end residential customers; and energy service provider D may be interested in buying any of energy service provider A's, B's, or C's electricity customers. Additionally, the before-mentioned energy service providers may opt to trade one customer-type for another customer-type with another energy service provider. For example, energy service provider A may be interested in trading a certain number of its industrial customers for a certain number of energy service provider B's high-end residential customers.

Currently, when energy service providers have an interest in transferring their assets (including parts of its customer base), they must contact via telephone other energy service providers to inquire whether they have similar assets available for sale or trade, or whether they would be interested in acquiring certain assets. This proves to be a tedious, inefficient, and time-consuming process as the electric and gas utility industries (as well as other industries) continue to deregulate and change across the nation.

Now that Electronic Commerce (E-commerce) technologies (involving the internet) are maturing, an opportunity now exists to improve the efficiency of the process typically practiced when the need arises to transfer, sell, trade, or otherwise dispose of existing utility assets (such as an existing customer base that the utility no longer wishes to service), by using a set of processes and associated apparatus that are typically used by the e-commerce technologies during and in combination with the processes and associated apparatus that are used during the transfer of utility assets.

The use of such e-commerce technologies has been disclosed in the prior art. For example, in U.S. Pat. No. 5,897,620 to Walker et al., a method and apparatus is disclosed for the sale of airline-specified flight tickets. However, the use of e-commerce technologies and processes for use in combination with the transfer of assets belonging to a utility-based commodity (such as a water, gas, or electric utility), particularly in regard to the sale or trade of an existing customer base, has not been disclosed, taught, or suggested in the prior art.

### SUMMARY OF THE INVENTION

Therefore, a need has arisen for a method and system for efficiently facilitating the transfer of a utility-based commodity's assets. More specifically, a need has arisen for a method and system for efficiently facilitating the transfer of a utility-based commodity's customer base or a portion of its customer base. Accordingly, it is an object of the present invention to disclose a method and associated apparatus for the transfer of utility assets, including but not limited to the transfer of a utility's customer base or portion of its customer base, using electronic commerce (e-commerce) technologies and processes, thereby improving the efficiency and ease by which the utility performs the transfer. More specifically, it is an object of the present invention to disclose a method and associated apparatus for the efficient transfer of utility assets, where one or more than one first company potential business partners can post via the internet the assets that they are making available for transfer to the website of a third company facilitator, and where one or more than one second company potential business partners can view the assets that are available for transfer via the internet on the third company facilitator's website, and when any second company potential business partner indicates via the internet an intention to acquire the assets of any of the first company potential business partners, the third company facilitator facilitates the completion of the business transaction.

As a result of the above object of the present invention, the invention concerns a method using electronic commerce for performing a transfer of a utility's customer base. The method involves the use of a computer that is adapted to access the internet for performing the transfer of assets. Using a computer, a potential seller accesses via the internet a website belonging to a third company facilitator and posts information about one or more utility customers it wishes to make available for transfer. Using a computer, a potential buyer accesses via the internet a website belonging to the third company facilitator and views the information posted by the potential seller concerning the one or more utility customers the seller has made available for transfer. The potential buyer can view detailed information about each customer or a group of customers, such as an energy customer-type per customer or group of customers, a load customer-type per customer or group of customers, a load characteristic of the group of customers, a load characteristic of each individual customer, and the location of each customer or group of customers. The buyer can also search through the information by sorting the customers available for transfer by energy customer-type (such as water, gas, or electric-type customers), by load customer-type (such as industrial, commercial, or residential customer-type or by actual load data), and by geographic location (such as by country, state or province, city, county, or other geographic region). The third company facilitator acquires information about the buyer's viewing habits while the buyer is accessing the information on the third company facilitator's website. If the buyer is interested in acquiring the seller's one or more utility customers that are posted to the third company facilitator's website by the seller, the buyer indicates an intention via the third company facilitator's website and indicates which utility customer or group of utility customers of the seller the buyer wishes to acquire.

The invention also concerns a method for performing a transfer of the assets of a utility-based commodity by using electronic commerce (e-commerce) technologies and processes thereby improving the efficiency of the performance of the transfer of utility assets.

The invention also concerns an e-commerce based data processing system that consists of a first server, a second server, and a third server and at least one personal computer/workstation connected to the third server that is adapted for use by a third “facilitator” company. The third server is accessible via the internet to the first server, which is adapted for use by a first company potential business partner. The third server is also accessible via the internet to the second server, which is adapted for use by a second company potential business partner. The third company functions as a facilitator for facilitating a culmination or a completion of a business transaction between the first company and the second company.

The invention concerns the above referenced e-commerce based data processing system, wherein the business transaction may include the transfer of utility assets.

The invention concerns the above referenced e-commerce based data processing system, wherein the utility assets include the transfer of a utility's customer base.

The invention concerns the above referenced e-commerce based data processing system, wherein, when the second company accesses the internet and logs onto the third server of the third company, the second company's username and password is validated, the second company's clearance level is validated, and the second company's credit history is validated, whereupon: (1) the second company then views on its workstation display screen a display that has a plurality of options including the ability to use one or more selected software applications that reside on the third company's third server, (2) the second company selects one or more of these software applications, a set of data (and in particular a set of utility asset data), and a set of parameters relevant to the use of that set of data, (3) the third server of the third company unlocks the selected software application and the data and executes the selected software application using the selected data and the selected parameters, and (4) a set of results are displayed remotely at the second company's workstation or personal computer.

The invention concerns the above referenced e-commerce based data processing system, wherein at the end of the session being executed on the third company's server, the third company's third server calculates the value of the applications and data that have been used, and an amount is charged against an account that has been established with the second company.

The invention concerns the above referenced e-commerce based data processing system, wherein when the second company logs off, the second company's selected parameters are saved both on the third company's third server and on the second company's computer for future use as a history file.

The invention concerns the above referenced e-commerce based data processing system, wherein, when the second company logs into the third server of the third company, a set of security levels of the user are checked and validated.

The invention concerns the above referenced e-commerce based data processing system, wherein a “granularity” of the security levels transcends from a high level to a lower level, as follows: (1) access to the third company's website or portal is controlled, (2) access to specific services offered within that website is controlled, (3) access to certain data, information types is controlled, (4) access to different resolutions of the data is controlled, and (5) each data element of the property owner's data is tagged with its own security level, the tag being further controlled by the owner of the data.

The invention concerns a method for storing and viewing data at successively higher user selectable levels of resolution, which includes utilizing a graphical model, viewing a customer demographic available for transfer as a layer of information, and further viewing data linked to that customer demographic including the number of customers available for transfer, the load characteristics for that customer demographic, and the load characteristics for each customer within the customer demographic.

The invention concerns a method using electronic commerce for facilitating a transfer of utility information, where a potential buyer accesses a third company facilitator's website to view information posted by one or more potential sellers, and the third company facilitator acquires information concerning the buyer's usage and viewing habits while the buyer is accessing the information posted by one or more potential sellers on the third company facilitator's website.

The invention concerns a method using electronic commerce for performing a transfer of utility assets, the method involving the use of a computer, the computer adapted to access an internet for performing the transfer of assets. The method includes the use of a computer by a second company to access the internet for obtaining and viewing a web page belonging to a third company facilitator, such web page containing information belonging to a first company which relates to the transfer of utility assets; and (b) if such second company is interested in such information being displayed on the third company's web page and which belongs to the first company, the use of the third company web page by the second company to complete a business transaction with the first company.

The invention concerns the above-referenced method using electronic commerce for performing a transfer of utility assets, wherein the information being displayed on the third company's web page, being accessed by the second company, and belonging to the first company relates to a customer base of the first company offered for transfer, the first company selling or trading the customer base, and the second company accessing the third company's web page when the second company is interested in acquiring the customer base available from the first company.

The invention concerns a method for performing and practicing the transfer of utility assets comprising the steps of: (1) using a computer, accessing, by a second company, an internet, (2) when the internet is accessed, accessing, by the second company, a third company server, (3) when the third company server is accessed, further accessing a website of the third company, (4) when the third company website is accessed, accessing, by the second company, a list of information in the third company website for the purpose of performing a business transaction with a first company, (5) during the step of accessing the list of information in the third company website, indicating an intention, by the second company, to complete the business transaction with the first company, and (6) when the step of indicating the intention is implemented, completing by the second company said business transaction with the first company.

The invention concerns the above-referenced method for performing and practicing the transfer of utility assets, wherein the list of information in the third company website comprises a list of a plurality of customers available for transfer by the first company.

The invention concerns a method for performing and practicing the transfer of utility assets, wherein the indicating step for indicating the intention by the second company to complete the business transaction with the first company comprises the step of indicating an intention to purchase one or more of the customers from the first company.

The invention concerns a method for performing and practicing the transfer of utility assets, wherein the step of accessing a website of the third company includes the further steps of accessing a public area for viewing an asset list, accessing a registered user's area for viewing an asset summary and for executing a confidentiality agreement, and accessing a confidential area after the confidentiality agreement is executed for viewing details of the customers listed on the customer list and described in the customer summary.

By way of example only (which example is not intended to limit the present invention), one such sub-web page, which is stored in the third server of the third company facilitator, stores data and other information relating to one or more assets which is/are available for transfer by the first company potential business partners. The first company potential business partners posted via the internet their assets, which are available for transfer, on the third company's third server in order to enable the third company to function as a facilitator for facilitating the transfer of the utility assets to one or more than one second company potential business partners. In operation, when a second company potential business partner is interested in purchasing or trading (or otherwise acquiring) utility assets, the second company uses a computer to access, via the internet, the main web page of a third company facilitator. When the main web page is accessed, the second company uses its computer to access (also via the internet and via the main web page of the third company) a sub-web page of the third company, which contains the specific information regarding utility assets that are available for transfer by one or more than one first company potential business partner. That asset information belongs to the first company potential business partner that posted its information to the third company server. Using that sub-web page of the third company, the second company examines the asset information regarding the assets belonging to each first company potential business partner that are available for transfer. If the second company is interested in purchasing, trading, or otherwise acquiring the assets belonging to any of the first company potential business partners, the second company, while still using a computer to access the third company facilitator's third server and other sub-web pages of the third company, agrees to purchase and/or trade the utility assets. The second company will then view, via the computer while accessing the third company's third server, a purchase and sale agreement, a trade agreement, or other transfer of assets agreement, whereby the second company agrees to buy and/or trade a particular first company's assets. A “closing” will take place at another physical location.

Further scope of the applicability of the present invention will become apparent from the detailed description presented hereinafter. It should be understood, however, that the detailed description and the specific examples, while representing an embodiment of the present invention, are given by way of illustration only, since various changes and modifications within the spirit and scope of the invention will become obvious to one skilled in the art from a reading of the following detailed description.

### BRIEF DESCRIPTION OF THE DRAWINGS

A full understanding of the present invention will be obtained from the detailed description of the embodiment presented herein below, and the accompanying drawings, which are given by way of illustration only and are not intended to limit the present invention, and wherein:

FIG. 1 is a basic diagram depicting a method, in accordance with the present invention, which is practiced by an infinite number of first company potential business partners and an infinite number of second company potential business partners for performing a transfer of utility assets, including the step of using a computer to access the internet for the purpose of completing a business transaction between any of the first companies and any of the second companies.

FIG. 2 is a basic block diagram depicting a method, in accordance with the present invention, which is practiced by a particular first company potential business partner and a particular second company potential business partner for performing a transfer of utility assets, including the step of using a computer to access the internet for the purpose of completing a business transaction between the first company and the second company;

FIG. 3 is a schematic of the first company potential business partner, the second company potential business partner, and the third company facilitator using the method of FIG. 2;

FIG. 4 illustrates a data processing system including a second server of a second company potential business partner, and a first server of a first company potential business partner, accessing the third server of a third company facilitator via the internet;

FIG. 5 illustrates a log in screen where a first company or a second company logs in to post or view assets available for transfer;

FIG. 6 illustrates the options available to a second company wishing to acquire assets via a third company facilitator's webpage where a first company posts utility assets for transfer and where the second company can evaluate those assets to determine if the second company will acquire certain assets;

FIGS. 7 through 10 illustrate sub-web pages of the third company facilitator wherein the first company can post information about assets available for transfer and the second company can evaluate that information to determine if the second company will acquire that asset;

FIG. 11 illustrates how the second company can indicate its intention to acquire a specific asset from the first company and how a “closing” will take place where the transfer of such specific utility assets from the first company to the second company will take place.

### DESCRIPTION OF THE PREFERRED EMBODIMENT

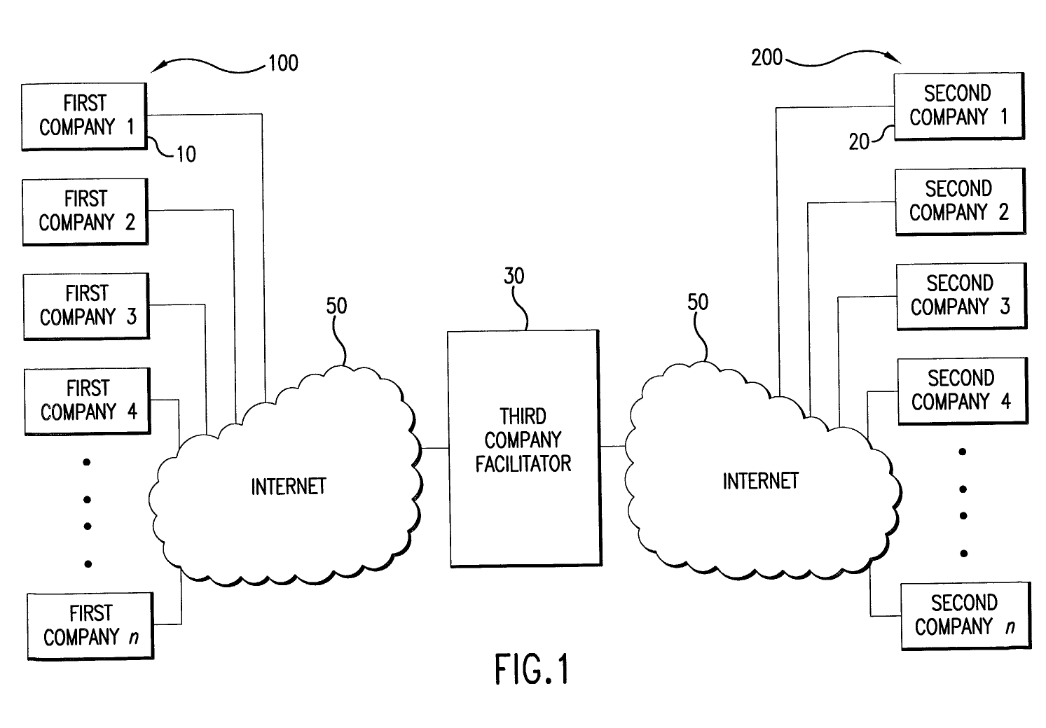

Referring to FIG. 1, a method, in accordance with the present invention, is illustrated which makes maximum use of Electronic Commerce “E-commerce” technologies (i.e., using a computer to access the internet) during the performance of an online transfer of the assets of a utility-based commodity. In FIG. 1, an infinite number of first companies 100 and an infinite number of second companies 200 wish to perform a business transaction. Specifically, the first companies wish to transfer (i.e., sell or trade) utility assets, such as a utility's customer base or a portion of its customer base. In other words, any first company is a potential “seller” of its utility customer base or a portion of its customer base. In contrast, the second companies wish to acquire utility assets, such as utility customers. In other words, any second company is a potential “buyer” of any of the assets made available by the first company sellers. Though any second company buyer can perform a business transaction with any first company seller, for explanatory purposes only, a single transaction will be described between first company seller 10 and second company buyer 20. Additionally, though the third company facilitator could also be a first company seller 10 or a second company buyer 20 in any given transaction or potential transaction, for the purposes of explanation only, the third company facilitator will be described as performing only its third company facilitating role.

In FIG. 1, a first company 10 wishes to transfer its customer base or a portion thereof. It logs into the third company facilitator's system via the internet to post information regarding the assets it wishes to transfer. A second company 20 wishes to acquire a customer or a group of customers. The second company 20 logs into the third company facilitator's system to view which assets are available for transfer. Upon reviewing the assets available, the second company 20 may decide that it wishes to perform the business transaction with the first company 10. A third company 30 performs the function of a “facilitator” for facilitating the completion of the business transaction between the first company 10 and the second company 20 over the Internet 50.

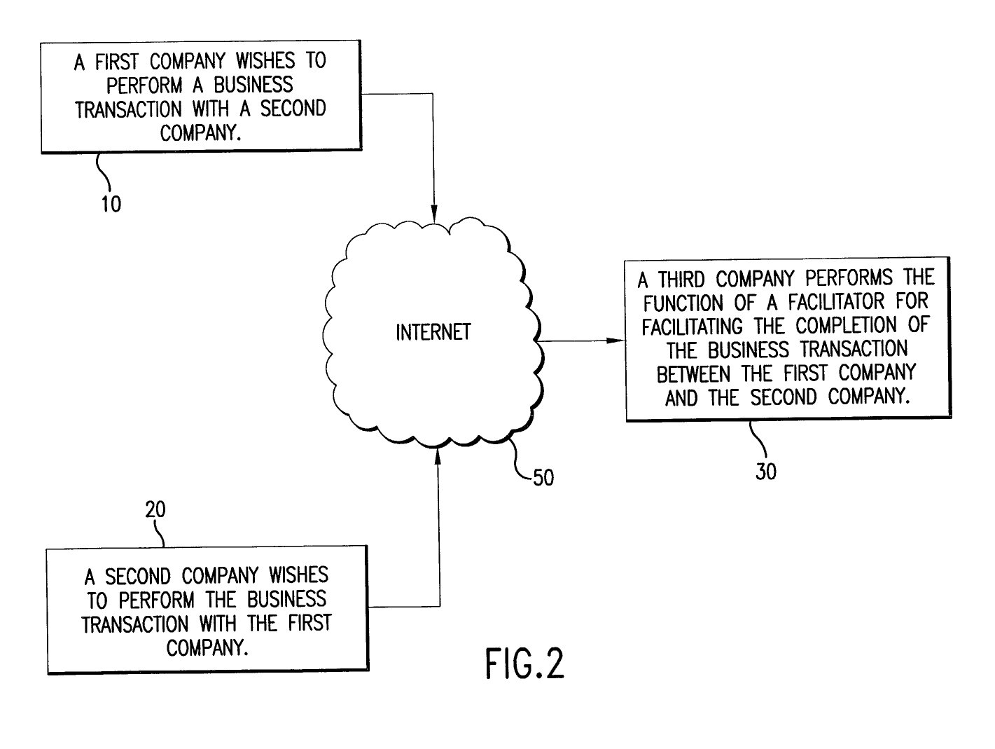

Referring to FIG. 2, a block diagram illustrating a business transaction being performed between a first company 10 and a second company 20. The first company has decided it wishes to transfer (i.e., sell or trade) a utility asset, such as a customer base or a portion of its customer base. The second company 20 has decided it wishes to acquire (i.e., buy or trade) the specific asset of the first company 10. The third company 30 facilitates the business transaction between the first company 10 and the second company 20 over the Internet 50.

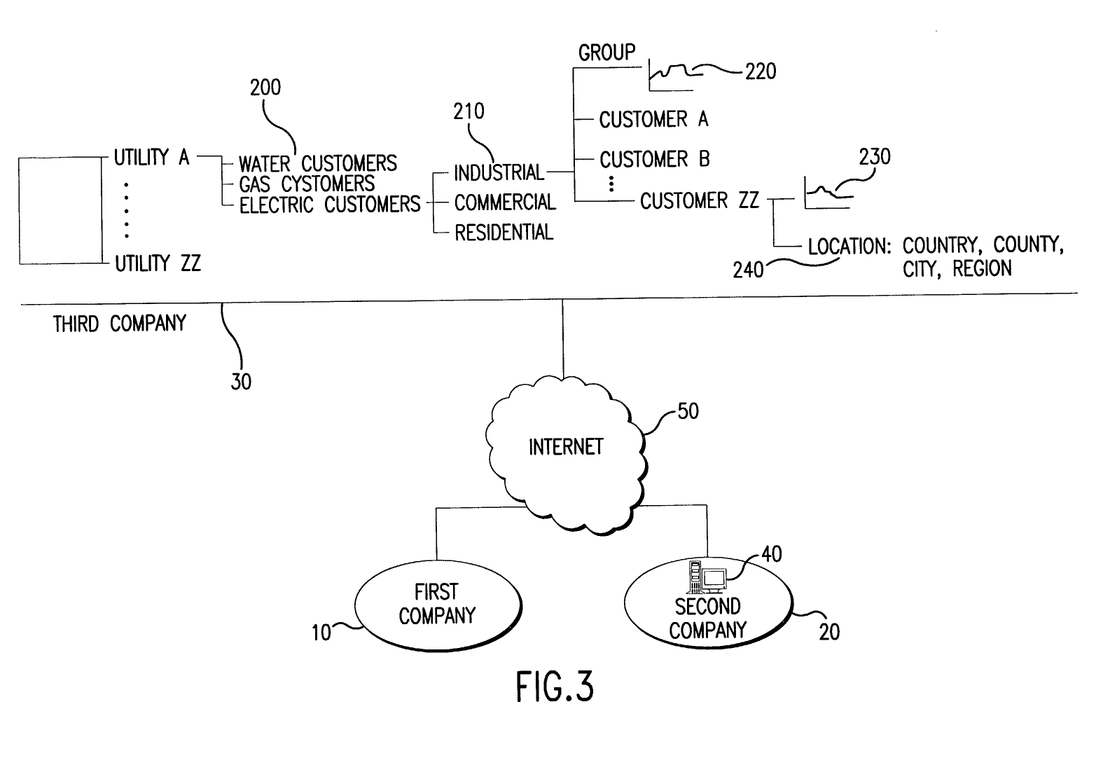

Referring to FIG. 3, a schematic drawing of the interaction between the first 10, second 20, and third companies 30 of FIG. 1 is illustrated. In FIG. 2, the third company 30 is the “facilitator.” That is, the third company 30 stores detailed information regarding the business transaction that has been posted to its system by the first company 10 via the internet. If the business transaction involves the transfer of utility assets (for example, a portion of a utility's customer base), the third company 30 stores detailed information regarding that available asset for transfer, such as the energy customer-type 200 (such as water, gas, electric), the load customer-type 210 (such as industrial, commercial, residential), the number of customers available, the load characteristics of the group of customers 220, the load characteristics of each individual customer 230, and the location of the customer 240. Additionally, the third company facilitator 30 monitors and stores detailed information about the usage and viewing activity of the second company 20 as the second company 20 uses the third company facilitator's system. The second company 20 can access the information belonging to the third company 30 by using a computer 40 to access the internet 50.

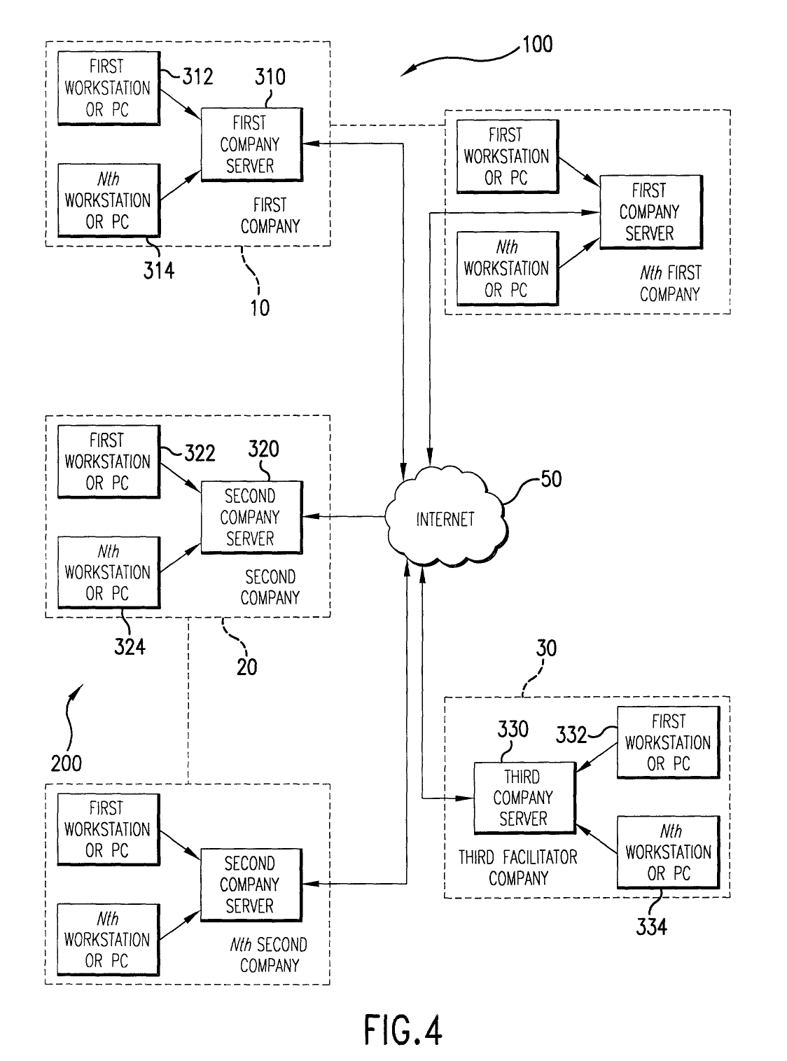

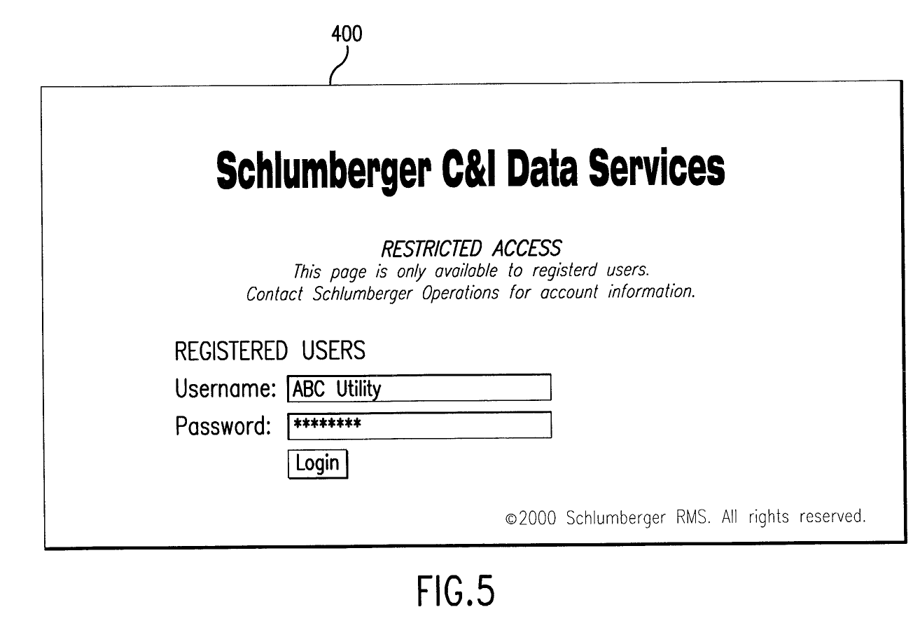

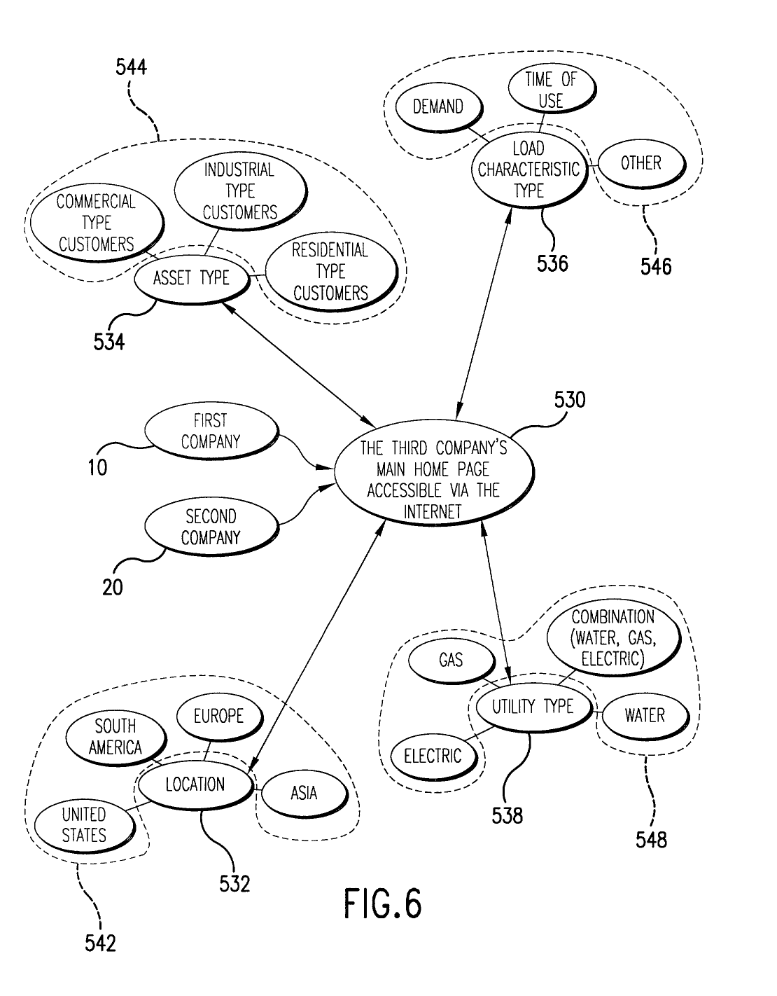

Referring to FIG. 4, a system block diagram illustrates the first company 10 wishing to perform a business transaction with a second company 20, the second company 20 wishing to perform the business transaction with the first company 10, and the third company 30 performing the function of a “facilitator” for facilitating the completion of the business transaction between the first company 10 and the second company 20 over the internet 50. Of course, any first company of an infinite number of first companies 100 and any second company of an infinite number of second companies 200 can perform a business transaction for the transfer of a first company's assets over the internet 50. However, for explanatory purposes, only one business transaction will be described between a first company 10 and a second company 20 performed over the internet 50. In the system block diagram of FIG. 4, the first company 10 has a server 310 and a first workstation or PC 312 is connected to the server 310 and any number of additional workstations or PCs 314 are connected to the server 310. The second company 20 has a server 320, and a first workstation or PC 322 is connected to the server 320 and any number of additional workstations or PCs 324 are connected to the server 320. The first company server 310 and the second company server 320 are operatively connected to a server 330 of a third company 30 via the Internet 50. The third company server 330 has a first workstation or PC 332 connected thereto and any number of additional workstations or PCs 334 connected thereto. The functional operation of the system block diagram of FIG. 4 will become apparent from a reading of the paragraphs set forth below with reference to FIG. 5, and with further reference to FIGS. 6 through 11.

Referring to FIGS. 4, 5, and 6 recall from FIG. 4 that the second company 20 (wishing to perform a business transaction with the first company 10) accesses the third company server 330 via the internet 50, since the third company 30 performs the function of a facilitator for facilitating the completion of the business transaction between the first company 10 and the second company 20. In FIG. 6, the first company 10 and the second company 20 each have access, via the internet 50, to the third company's main “home page” 530. However, before accessing the homepage, the first company 10 and the second company 20 must first log in to the third company's server 330 through a log in screen 400. After logging in to the server 330, the first company 10 or the second company 20 will now view several web pages on its computer, and those web pages are discussed below with reference to FIGS. 6 through 11 of the drawings.

In FIG. 6, the first company 10 and the second company 20 each have access, via the internet 50, to the third company's main “home page” 530. Because the first company 10 is interested in making its assets available for transfer to any second company, it will access the third company's server 330 and main home page 530 via the Internet 50 to post information about the assets it wishes to make available. Similarly, since the second company 20 is interested in performing a business transaction with any first company by accessing the third company facilitator's server 330, the second company 20 will access the main “home page” 530 of the third company's server 330 for the purpose of evaluating the assets available for transfer, including the assets posted as available for transfer by the first company 10. The second company 20 may at any time access that home page 530 of the third company 30 to complete a business transaction between it and any first company.

In FIG. 6, therefore, the second company 20 accesses, via the internet, the third company's main “home page” 530 of the third company's server 330. When the second company 20 has accessed the main “home page” 530 of the third company 30, the second company 20 must then decide which “business transaction” it will attempt to complete with another first company. In FIG. 6, assume that the third company's 30 server 330 stores four different sub-web pages in association with its main “home page” 530, the four different sub-web pages of FIG. 6 involving four different means of searching for assets available for transfer: (1) Search Assets by Location sub-web page 532, (2) Search by Asset Type sub-web page 534, (3) Search by Load Characteristic sub-web page 536, and (4) Search by Utility Type sub-web page 538. In FIG. 6, assume further that the second company 20 decides to access the Search by Load Characteristic sub-web page 536 after having accessed the third company's main “home page” 530 that is stored in the third company's server 330.

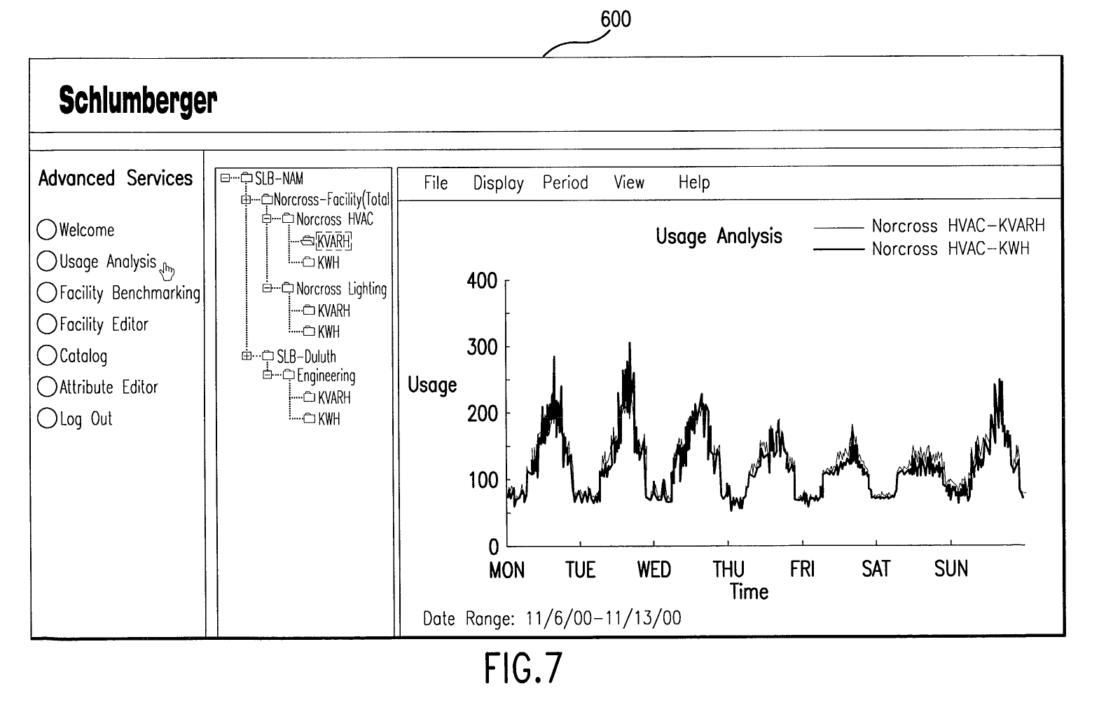

Referring to FIGS. 7 through 10, and referring initially to FIG. 6, recalling that the second company 20 has accessed the “Search by Load Characteristic” sub-web page (hereinafter called the “Load Characteristic web page”) 536, which was accessed from the third company's main “home page” 530, and which is stored in the third company server 330, the second company 20 will specify what load characteristics the assets it wishes to acquire should have by navigating through additional sub-web pages 546 and by entering additional information. The second company will then click the “search” button. This will allow the second company to view assets available for transfer that match the specified load criteria, including the assets available for transfer by the first company 10 that match the specified load criteria.

After the search is performed and the results are displayed in FIG. 6, the second company 20 may wish to view certain weekly load characteristics for a group of customers. FIG. 7 illustrates the graphical results 600 obtained upon performing a load characteristic search on a group of customers available for transfer.

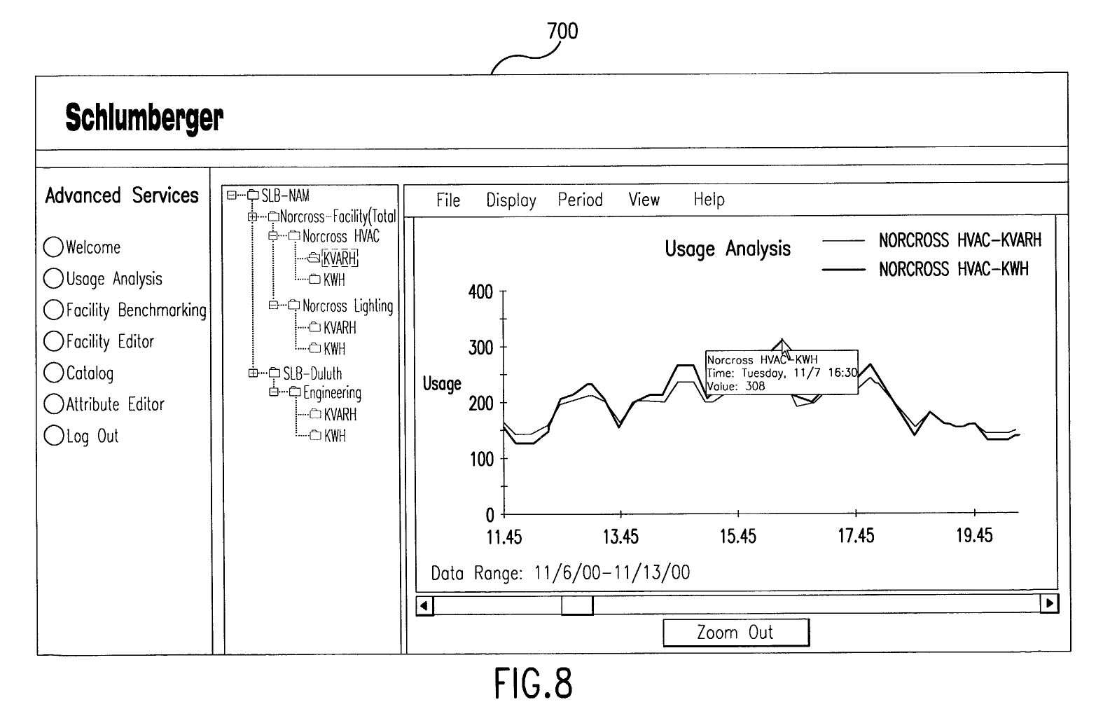

Additionally, after the search is performed and the results are displayed in FIG. 6, the second company 20 may wish to view certain load characteristics per end customer. FIG. 8 illustrates the graphical results 700 of a daily load characteristic for a particular customer available for transfer.

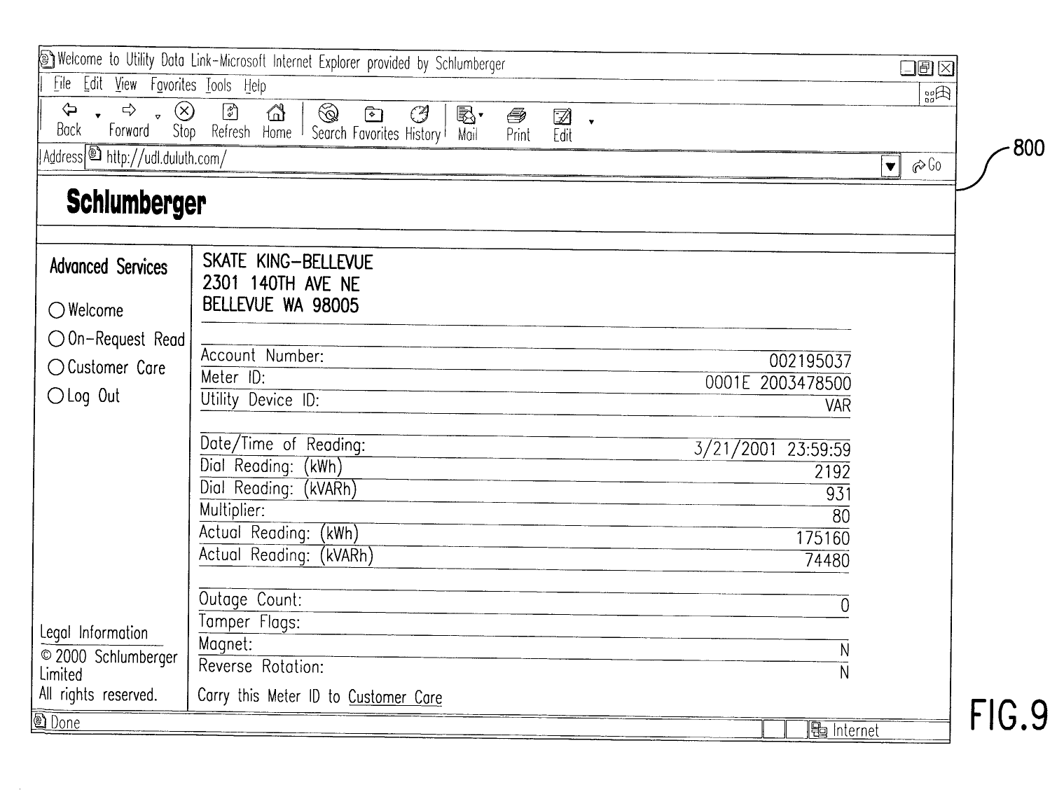

Similarly, after the search is performed and the results are displayed in FIG. 6, the second company 20 may wish to view certain load characteristic information per end customer or per group of customers. FIG. 9 illustrates the tabular results 800 obtained upon performing a load characteristic search on a particular customer available for transfer.

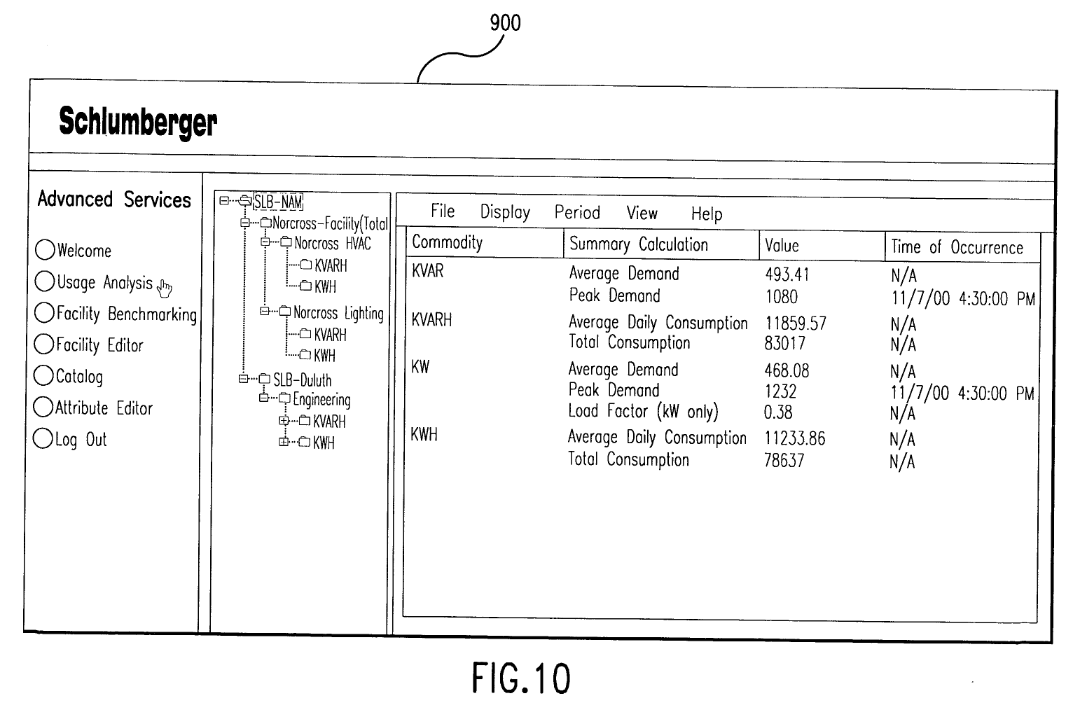

In addition to the search performed and the results displayed in FIGS. 6-9, the second company 20 may wish to view the load characteristics of a specified group of customers available for transfer by the first company 10. FIG. 10 illustrates the tabular results 900 obtained upon performing a load characteristic search on a group of customers available for transfer.

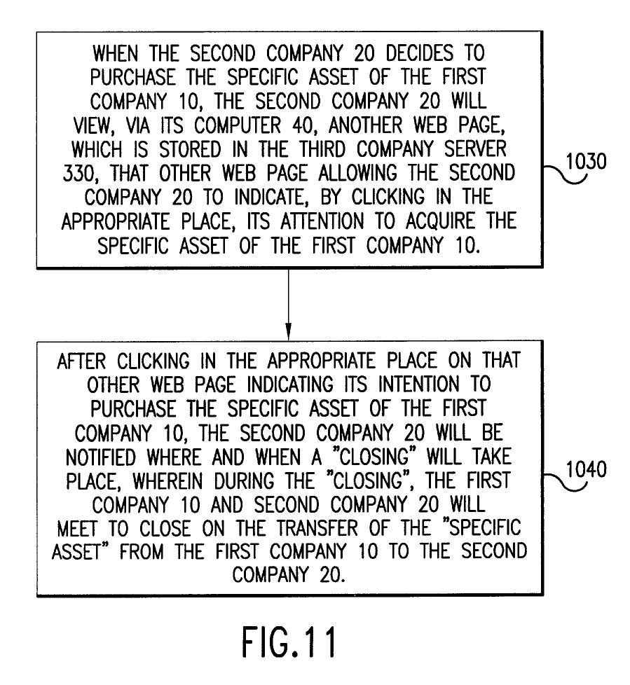

Referring to FIG. 11, when the second company 20 decides to purchase the asset from the first company 10, the second company 20 will view, via its computer 40, another web page 1030 which is stored in the third company server 330, that other web page 1030 allowing the second company 20 to indicate, by clicking in the appropriate place, its intention 1030 to acquire the utility asset. In FIG. 11, after clicking in the appropriate place on that other web page 1030 indicating its intention to acquire the asset of FIG. 11, the second company 20 will be notified where and when a “closing” will take place 1040, wherein during the “closing,” the first company 10 and the second company 20 will meet to close on the transfer of the asset from the first company 10 to the second company 20.

A functional description of the operation of the present invention will be set forth in the following paragraphs with reference to FIGS. 1 through 11 of the drawings.

A first company seller 10 has a plurality of utility assets (i.e., a customer base or a portion of a customer base) available for transfer. For example, a first company 10 has a number of residential customers it wishes to dispose of by sale or trade. In order to facilitate the transfer of this customer base, the first company 10 posts via the internet 50 information regarding the customer group that is available for sale or trade on a server 330 of a third company 30. A second company buyer 20, wishing to acquire (i.e., purchase or trade) a group of customers, uses its computer 40 to access the internet 50 for the purpose of further accessing a third company server 330 that belongs to the third company 30. When the second company 20 accesses the third company server 330, the second company 20 accesses the third company main “home page” 530. The second company 20 can now access the sub-web pages pertaining to the assets available for transfer by any first company who has posted such information. The second company 20 can search for assets available for transfer by location 532 (for example, by country 542, state, region, city, county, etc.), by utility type 538 (for example, by water customers, gas customers, electricity customers, or any combination thereof 548), by the load characteristics of the assets available for transfer 536 (such as by time of use, by demand readings, or by other load characteristic criteria 546), by the load characteristics of each individual customer, by the customer demographic of each group of customers, or by the asset type 534 (by commercial type customers, industrial type customers, residential type customers, or any combination thereof 544). If the second company 20 wants to acquire a group of customers, the second company 20 clicks in the appropriate place to indicate its intention to acquire the customer asset 1030. As a result, the first company 10 and the second company 20 will meet in a separate place to “close” on the sale or trade of the customer asset 1040 from the first company 10 to the second company 20.

The above discussion is presented under the “Description of the Preferred Embodiment.” The following discussion is presented under the “Detailed Description of the Preferred Embodiment.”

### DETAILED DESCRIPTION OF THE PREFERRED EMBODIMENT

The detailed specification set forth below discloses the details that would enable one skilled in the art to make the invention of this application. In the following detailed specification, the invention of this application as described above is part of an overall project, and the name of that project is: Blue Lightening.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method using electronic commerce for performing a transfer of a utility's customer base, the method involving the use of a computer, the computer adapted to access an internet for performing the transfer of assets, comprising the steps of:
using a computer, a potential seller accessing via the internet a website belonging to a third company facilitator and posting information about one or more utility customers it wishes to make available for transfer;
using a computer, a potential buyer accessing via the internet a website belonging to the third company facilitator and viewing the information posted by the potential seller concerning the one or more utility customers the seller has made available for transfer, wherein viewing the information includes viewing detailed information about each customer or a group of customers, such as an energy customer-type per customer or group of customers, a load customer-type per customer or group of customers, a load characteristic of the group of customers, a load characteristic of each individual customer, and the location of each customer or group of customers, and wherein viewing the information also includes the buyer searching through the information by sorting the customers available for transfer by energy customer-type (such as water, gas, or electric-type customers), by load customer-type (such as industrial, commercial, or residential customer-type or by actual load data), and by geographic location (such as by country, state or province, city, county, or other geographic region);
the third company facilitator acquiring information about the buyer's viewing habits while the buyer is accessing the information on the third company facilitator's website; and
if the buyer is interested in acquiring the seller's one or more utility customers that are posted to the third company facilitator's website by the seller, the buyer indicating an intention via the third company facilitator's website, wherein indicating an intention includes indicating which utility customer or group of utility customers of the seller the buyer wishes to acquire.

2. A method for performing a transfer of the assets of a utility-based commodity comprising the steps of:
performing a transfer of utility assets, this performing step including the further step of,
using electronic commerce (e-commerce) technologies and processes during the performing and practicing step thereby improving the efficiency of the performance of the transfer of utility assets.

3. An e-commerce based data processing system comprising:
A first server,
A second server,
And a third server and at least one personal computer/workstation connected to the third server that is adapted for use by a third “facilitator” company,
The third server being accessible via the internet to the first server, which is adapted for use by a first company potential business partner,
The third server being accessible via the internet to the second server, which is adapted for use by a second company potential business partner,
The third company functioning as a facilitator for facilitating a culmination or a completion of a business transaction between the first company and the second company.

4. The e-commerce based data processing system of claim 3, wherein the business transaction is a transfer of utility assets from the first company to the second company.

5. The e-commerce based data processing system of claim 4, wherein the utility assets include the transfer of a utility's customer base.

6. The e-commerce based data processing system of claim 3, wherein, when the second company accesses the internet and logs onto the third server of the third company, the second company's username and password is validated, the second company's clearance level is validated, and the second company's credit history is validated, where upon: (1) the second company then views on its workstation display screen a display that has a plurality of options including the ability to use one or more selected software applications that reside on the third company's third server, (2) the second company selects one or more of these software applications, a set of data (and in particular a set of utility asset data), and a set of parameters relevant to the use of that set of data, (3) the third server of the third company unlocks the selected software application and the data and executes the selected software application using the selected data and the selected parameters, and (4) a set of results are displayed remotely at the second company's workstation or personal computer.

7. The e-commerce based data processing system of claim 6, wherein at the end of the session being executed on the third company's server, the third company's third server calculates the value of the applications and data that have been used, and an amount is charged against an account that has been established with the second company.

8. The e-commerce based data processing system of claim 6, wherein when the second company logs off, the second company's selected parameters are saved both on the third company's third server and on the second company's computer for future use as a history file.

9. The e-commerce based data processing system of claim 3, wherein, when the second company logs into the third server of the third company, a set of security levels of the user are checked and validated.

10. The e-commerce based data processing system of claim 9, wherein a “granularity” of the security levels transcends from a high level to a lower level, as follows: (1) access to the third company's website or portal is controlled, (2) access to specific services offered within that website is controlled, (3) access to certain data, information types is controlled, (4) access to different resolutions of the data is controlled, and (5) each data element of the property owner's data is tagged with its own security level, the tag being further controlled by the owner of the data.

11. A method for storing and viewing data at successively higher user selectable levels of resolution, comprising the steps of: utilizing a graphical model, viewing a customer demographic available for transfer as a layer of information, and further viewing data linked to that customer demographic including the number of customers available for transfer, the load characteristics for that customer demographic, and the load characteristics for each customer within the customer demographic.

12. A method using electronic commerce for facilitating a transfer of utility information, comprising the steps of:
a potential buyer accessing a third company facilitator's website to view information posted by one or more potential sellers; and
the third company facilitator acquiring information concerning the buyer's usage and viewing habits while the buyer is accessing the information posted by one or more potential sellers on the third company facilitator's website.

13. A method using electronic commerce for performing a transfer of utility assets, the method involving the use of a computer, the computer adapted to access an internet for performing the transfer of assets, comprising the steps of: (a) using the computer, accessing, by a second company, the internet for obtaining and viewing a web page belonging to a third company facilitator, such web page containing information belonging to a first company which relates to the transfer of utility assets; and (b) if such second company is interested in such information being displayed on the third company's web page and which belongs to the first company, using, by such second company, the third company web page to complete a business transaction with the first company.

14. The method for performing the transfer of utility assets of claim 13, wherein the information being displayed on the third company's web page, being accessed by the second company, and belonging to the first company relates to a customer base of the first company offered for transfer, the first company selling or trading the customer base, and the second company accessing the third company's web page when the second company is interested in acquiring the customer base available from the first company.

15. A method for performing and practicing the transfer of utility assets comprising the steps of: (1) using a computer, accessing, by a second company, an internet, (2) when the internet is accessed, accessing, by the second company, a third company server, (3) when the third company server is accessed, further accessing a website of the third company, (4) when the third company website is accessed, accessing, by the second company, a list of information in the third company website for the purpose of performing a business transaction with a first company, (5) during the step of accessing the list of information in the third company website, indicating an intention, by the second company, to complete the business transaction with the first company, and (6) when the step of indicating the intention is implemented, completing by the second company said business transaction with the first company.

16. The method of claim 15, for performing and practicing the transfer of utility assets, wherein the list of information in the third company website comprises a list of a plurality of customers available for transfer by the first company.

17. The method of claim 15, for performing and practicing the transfer of utility assets, wherein the indicating step for indicating the intention by the second company to complete the business transaction with the first company comprises the step of indicating an intention to purchase one or more of the customers from the first company.

18. The method of claim 15, for performing and practicing the transfer of utility assets, wherein the step of accessing a website of the third company comprises the further steps of accessing a public area for viewing an asset list, accessing a registered user's area for viewing an asset summary and for executing a confidentiality agreement, and accessing a confidential area after the confidentiality agreement is executed for viewing details of the customers listed on the customer list and described in the customer summary.
